(19) United States
(12) Patent Application Publication
(10) Pub. No.: US 2014/0102087 A1
(43) Pub. Date: Apr. 17, 2014

(54) POWER TRANSMISSION DEVICE

(71) Applicant: Takao Fukunaga, Yawata-shi (JP)

(72) Inventor: Takao Fukunaga, Yawata-shi (JP)

(21) Appl. No.: 14/123,440

(22) PCT Filed: May 18, 2012
(86) PCT No.: PCT/JP2012/062819

§ 371 Date: Dec. 2, 2013

(30) Foreign Application Priority Data
Jun. 27, 2011 (JP) 2011-141401

(51) Int. Cl. F16D 1/02

(52) U.S. Cl. CPC F16D 1/02
USPC 60/331

(57) ABSTRACT

It is intended to provide a power transmission device that can efficiently transmit power. In the present power transmission device, a first stator is configured to direct a fluid to a turbine such that the turbine is rotated in a first rotational direction if a rotation restriction part allows the first stator and a second stator to be rotated in the first rotational direction. The first stator is configured to direct the fluid to the turbine such that the turbine is rotated in a second rotational direction if the rotation restriction part restricts the first stator and the second stator from being rotated in the first rotational direction and the second rotational direction.

### CROSS-REFERENCE TO THE RELATED APPLICATIONS

This application national stage application claims priority to Japanese Patent Application No. 2011-141401 filed on Jun. 27, 2011. The entire disclosure of Japanese Patent Application No. 2011-141401 is hereby incorporated herein by reference.

### BACKGROUND

1. Field of the Invention

The present invention relates to a power transmission device.

2. Background Art

Some torque converter units, embedded in well-known power transmission devices, include a torque converter for forward rotation and a torque converter for reverse rotation (e.g. see Design of Fluid Transmission Device, pages 44-45, Nov. 30, 1967, Ohmsha, Ltd.). In this type of torque converter unit, the forward-rotational torque converter is configured to be rotated by draining operating oil from the reverse-rotational torque converter and by supplying the operating oil to the forward-rotational torque converter. On the other hand, the reverse-rotational torque converter is configured to be rotated by draining the operating oil from the forward-rotational torque converter and by supplying the operating oil to the reverse-rotational torque converter.

In the torque converter unit of the aforementioned type, the operating oil circulates through an impeller, a stator and a turbine in this order within the reverse-rotational torque converter. The stator is stationary in the aforementioned configuration, and thereby, the turbine of the reverse-rotational torque converter is configured to be rotated oppositely (i.e., reversely) to a turbine of the forward-rotational torque converter. In this case, chances are that the operating oil flowing out of the turbine flows into the impeller so that the rotation of the impeller is restricted. In other words, the flow of the operating oil from the turbine into the impeller is supposed to act in a direction of suppressing the rotation of the impeller. Especially, this tendency becomes more remarkable as the rotation speed of the turbine is increased. Thus, in the reverse-rotational torque converter, torque (capacity) for rotating the impeller is more increased as the rotation speed of the turbine is increased.

It is an advantage of the present invention to provide a power transmission device that can efficiently transmit power.

### SUMMARY

A power transmission device according to a first aspect of the present invention includes an impeller disposed on an input side, a turbine disposed on an output side, a first stator, a second stator and a rotation restriction part. The impeller is configured to be rotated in a first rotational direction. The turbine is configured to be rotated in either the first rotational direction or a second rotational direction opposite to the first rotational direction. The first stator is configured to be rotatable in the first rotational direction between the impeller and the turbine in order to transmit a power of the impeller to the turbine. The second stator is configured to be rotatable in the first rotational direction between the turbine and the impeller in order to transmit a power of the turbine to the impeller. The rotation restriction part is configured to allow the first stator and the second stator to be rotated in the first rotational direction and restrict the first stator and the second stator from being rotated in the first rotational direction and the second rotational direction.

In the present power transmission device, the first stator is configured to introduce a fluid for transmitting the power to the turbine such that the turbine is rotated in the first rotational direction if the rotation restriction part allows the first stator and the second stator to be rotated in the first rotational direction. The first stator is configured to introduce the fluid to the turbine such that the turbine is rotated in the second rotational direction if the rotation restriction part restricts the first stator and the second stator from being rotated in the first rotational direction and the second rotational direction.

In this case, the turbine is configured to be rotated in the first rotational direction by the fluid directed by the first stator if the rotation restriction part allows the first stator and the second stator to be rotated in the first rotational direction. By contrast, the turbine is configured to be rotated in the second rotational direction by the fluid directed by the first stator if the rotation restriction part restricts the first stator and the second stator from being rotated in the first rotational direction and the second rotational direction. In other words, depending on whether or not the first stator and the second stator are rotated, the flow direction of the fluid introduced by the first stator is changed, and thereby, the rotational direction of the turbine is changed. Thus, according to the present power transmission device, power can be efficiently transmitted from the impeller to the turbine both if the turbine is rotated in the first rotational direction and if the turbine is rotated in the second rotational direction. Unlike a well-known device, the present power transmission device is not required to specially prepare a device for reverse rotation. Therefore, the present power transmission device can be further reduced in its size in comparison with the well-known device.

A power transmission device according to a second aspect of the present invention relates to the power transmission device according to the first aspect of the present invention. In the power transmission device, the impeller is configured to introduce the fluid to the first stator such that the first stator is rotated in the first rotational direction if the impeller is rotated in the first rotational direction.

In this case, if the impeller is rotated in the first rotational direction, the first stator is rotated in the first rotational direction by the fluid introduced by the impeller. Further, as described above, the turbine is rotated in the first rotational direction by the rotation of the first stator. Thus, even if the first stator exists, power can be reliably transmitted from the impeller to the turbine.

A power transmission device according to a third aspect of the present invention relates to the power transmission device according to the first or second aspect of the present invention. In the power transmission device, the first stator and the second stator are configured to be unitarily rotatable.

In this case, the first stator and the second stator are configured to be unitarily rotatable. Therefore, the rotation restriction part can simultaneously restrict the rotation of the first stator and that of the second stator. In other words, the rotation of the first stator and that of the second stator can be simultaneously allowed or restricted. Accordingly, the flow direction of the fluid introduced by the first stator can be reliably changed. In other words, the rotational direction of the turbine can be reliably changed.

A power transmission device according to a fourth aspect of the present invention relates to the power transmission device according to the third aspect of the present invention. In the power transmission device, the rotation restriction part is configured to restrict the first stator from being rotated by restricting the second stator from being rotated.

In this case, the first stator is configured to be unitarily rotatable with the second stator. Therefore, if the rotation restriction part restricts the rotation of the second stator, the rotation of the first stator is also restricted. In other words, the rotation of the first stator and that of the second stator can be both restricted only by restricting the rotation of the second stator. Accordingly, the present device is not required to prepare no special device for restricting the rotation of the first stator, and can be thereby reduced in its size.

A power transmission device according to a fifth aspect of the present invention related to the power transmission device according to any one of the first to fourth aspects of the present invention. In the power transmission device, the first stator is disposed on an outer peripheral side and between the impeller and the turbine. The second stator is disposed on an inner peripheral side and between the turbine and the impeller.

In this case, the first stator is disposed on the outer peripheral side, whereas the second stator is disposed on the inner peripheral side. Therefore, the present power transmission device can be structured without remarkably changing the arrangement configuration of the impeller, the turbine and the stator in the well-known device. In other words, the present power transmission device can be easily structured.

A power transmission device according to a sixth aspect of the present invention relates to the power transmission device according to any one of the first to fifth aspects of the present invention. In the power transmission device, the impeller, the turbine, the first stator and the second stator are included in a torque converter. The rotation restriction part is disposed in a transmission.

In this case, the torque converter includes the impeller, the turbine, the first stator and the second stator. Further, the transmission includes the rotation restriction part. For example, if a continuously variable transmission is used in a power transmission device, it is possible to forwardly rotate a pulley and so forth included in the continuously variable transmission without causing any problems. However, in attempting to reversely rotate the pulley and so forth, it is required to specially embed a gear or a mechanism corresponding to the gear into the transmission. In comparison with this, the present power transmission device can reversely rotate the turbine of the torque converter only with the rotation restriction part without preparing such special gear or mechanism. Therefore, the present power transmission device can be reduced in its size.

### BRIEF DESCRIPTION OF THE DRAWINGS

Referring now to the attached drawings which form a part of this original disclosure:

FIG. 1 is a skeleton diagram illustrating a power transmission device according to an exemplary embodiment of the present invention; and

FIG. 2 is a conceptual diagram illustrating actions of four elements in the power transmission device and flow lines of operating oil.

### DESCRIPTION OF THE EMBODIMENTS

### Practical Example 1

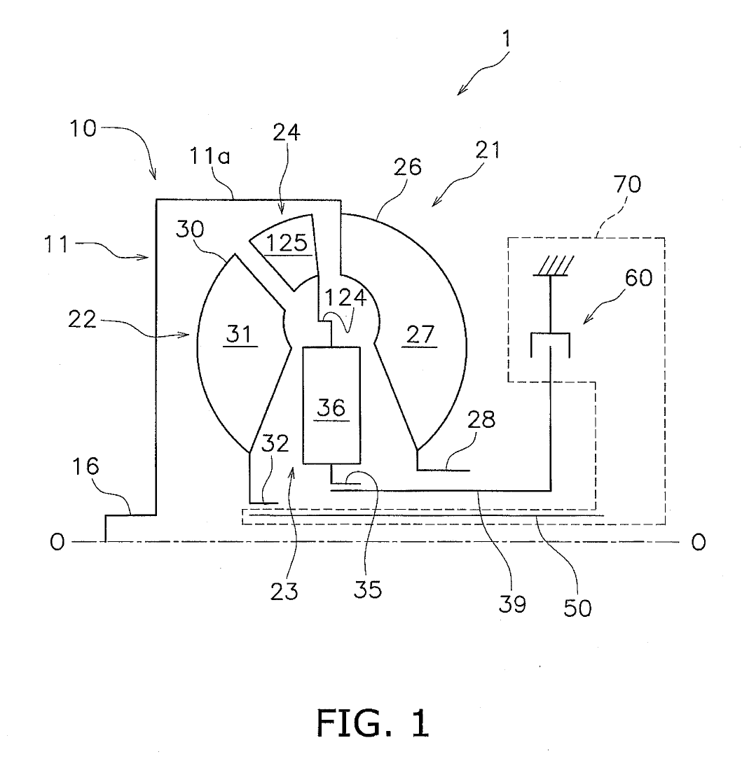

FIG. 1 is a skeleton diagram illustrating a power transmission device 1 as an exemplary embodiment of the present invention. In FIG. 1, an engine (not illustrated in the figure) is disposed on the left side, whereas a continuously variable transmission 70 is disposed on the right side. A line O-O depicted in FIG. 1 indicates a rotary axis of a torque converter 10. Entire Structure of Power Transmission Device

As illustrated in FIG. 1, the power transmission device 1 mainly includes the torque converter 10 and the continuously variable transmission 70 (hereinafter referred to as a transmission). The torque converter 10 is a device for transmitting torque from a crankshaft (not illustrated in the figure) of the engine to an input shaft 50 of the transmission 70.

The torque converter 10 includes a front cover 11 and a fluid actuation chamber 6 formed in a torus shape. The torus-shaped fluid actuation chamber 6 includes four types of rotation parts (an impeller 21, a turbine 22, a first stator 24 and a second stator 23).

The front cover 11 is a disc-shaped member, and is disposed on the engine side. The torque from the engine is inputted into the front cover 11. A center boss 16 is mounted to the inner peripheral end of the front cover 11. The center boss 16 is a cylindrical member extending in the axial direction, and is inserted into the center hole of the crankshaft. An outer peripheral side tubular portion 11a is formed on the outer peripheral part of the front cover 11, while being extending axially towards the transmission 70. The outer peripheral edge of an impeller shell 26 of the impeller 21 is fixed to the tip end of the outer peripheral side tubular portion 11a by welding. As a result, the front cover 11 and the impeller 21 form a fluid chamber filled with fluid for transmitting power (hereinafter referred to as operating oil).

The impeller 21 is configured to be unitarily rotatable in a first rotational direction. When being rotated in the first rotational direction, the impeller 21 introduces the operating oil to the first stator 24 such that the first stator 24 can be rotated in the first rotational direction. The impeller 21 mainly includes the impeller shell 26, a plurality of impeller blades 27 fixed to the inside of the impeller shell 26, and an impeller hub 28 fixed to the inner peripheral part of the impeller shell 26.

The turbine 22 is configured to be rotatable in either of the first rotational direction and a second rotational direction opposite to the first rotational direction. The turbine 22 is disposed axially in opposition to the impeller 21 within the fluid chamber. The turbine 22 mainly includes a turbine shell 30, a plurality of turbine blades 31 fixed to the impeller-side surface of the turbine shell 30, and a turbine hub 32 fixed to the inner peripheral edge of the turbine shell 30. A spline shaft is formed on the inner peripheral surface of the turbine hub 32 so as to be engaged with a spline groove formed on the outer peripheral surface of the input shaft 50. With the structure, the turbine hub 32 is configured to be unitarily rotatable with the input shaft 50.

The first stator 24 controls the rotational direction of the turbine 22 by regulating the flow of the operating oil flowing into the turbine 22 from the impeller 21. In other words, the first stator 24 controls the rotational direction of the turbine 22 by changing the flow direction of the operating oil to be introduced to the turbine 22. The first stator 24 is configured to be rotatable in the first rotational direction between the impeller 21 and the turbine 22 in order to transmit the power of the impeller 21 to the turbine 22.

The first stator 24 is disposed on the outer peripheral side and between the impeller 21 and the turbine 22. The first stator 24 mainly includes a stator coupling part 124 and a plurality of first stator blades 125. The stator coupling part 124 is a part to be coupled to the second stator 23. With the structure, the first stator 24 is unitarily rotated with the second stator 23. The plural first stator blades 125 are mounted to the outer peripheral part of the stator coupling part 124. The plural first stator blades 125 are disposed between the outer peripheral part of the impeller 21 and that of the turbine 22.

The second stator 23 amplitudes torque to be outputted from the turbine 22 by regulating the flow of the operating oil returning to the impeller 21 from the turbine 22. The second stator 23 is configured to be rotatable in the first rotational direction between the turbine 22 and the impeller 21 in order to transmit the power of the turbine 22 to the impeller 21. The second stator 23 is a member unitarily fabricated by casting of resin, aluminum alloy or so forth.

The second stator 23 is configured to introduce the operating oil such that the impeller 21 can be rotated in the first rotational direction both when a clutch 60 to be described allows the second stator 23 to be rotated in the first rotational direction and when the clutch 60 restricts the second stator 23 from being rotated in the first rotational direction. The second stator 23 is disposed between the inner peripheral part of the impeller 21 and that of the turbine 22. The second stator 23 mainly includes an annular stator shell 35 and a plurality of second stator blades 36. The stator shell 35 is supported by a tubular stationary shaft 39. Specifically, a spline shaft is formed on the inner peripheral surface of the stator shell 35 so as to be engaged with a spline groove formed on the outer peripheral surface of the stationary shaft 39. With the structure, the stator shell 35 is configured to be unitarily rotatable with the stationary shaft 39.

The continuously variable transmission 70 includes the input shaft 50, a power change mechanism (not illustrated in the figures) for continuously changing power inputted from the input shaft 50, and the clutch 60 (rotation restriction part). The clutch 60 (rotation restriction part) includes a mechanism for allowing the first stator 24 and the second stator 23 to be rotated in the first rotational direction and a mechanism for restricting the first stator 24 and the second stator 23 from being rotated in both the first rotational direction and the second rotational direction. Specifically, the stationary shaft 39 is allowed to be rotated when the clutch 60 is turned off. Accordingly, the first stator 24 and the second stator 23 become rotatable in the first rotational direction. The stationary shaft 39 is restricted from being rotated when the clutch 60 is turned on. Accordingly, the first stator 24 and the second stator 23 become non-rotatable in both the first rotational direction and the second rotational direction. Here, the first stator 24 and the second stator 23 are configured to be unitarily rotatable. Therefore, when only the rotation of the second stator 23 is restricted by the clutch 60, the rotation of the first stator 24 is also simultaneously restricted.

### Action of Power Transmission Device

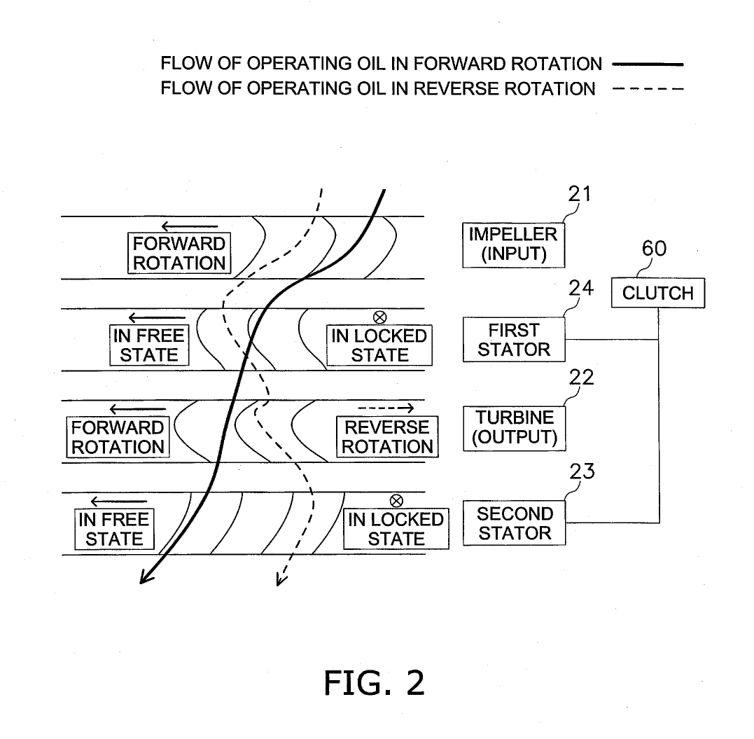

FIG. 2 is a conceptual diagram illustrating actions of four elements (the impeller 21, the turbine 22, the first stator 24 and the second stator 23) in the torque converter 10 and flow lines of the operating oil. In FIG. 2, rotation in the first rotational direction is represented as forward rotation, whereas rotation in the second rotational direction is represented as reverse rotation. In FIG. 2, the flow line of the operating oil in the forward rotation is depicted with a solid line, whereas that of the operating oil in the reverse rotation is depicted with a broken line. The action of the power transmission device 1 will be hereinafter explained with reference to FIG. 2.

### Clutch-off State

When the clutch 60 is being turned off, the first stator 24 and the second stator 23 are configured to be forwardly rotatable. When the impeller 21 is forwardly rotated under the condition, the operating oil is introduced from the impeller 21 to the first stator 24 by the impeller blades 27. Accordingly, the first stator 24 is forwardly rotated by the operating oil.

When the operating oil is then introduced from the first stator 24 to the turbine 22 by the first stator blades 125, the turbine 22 is forwardly rotated by the operating oil. In other words, the first stator 24 introduces the operating oil to the turbine 22 such that the turbine 22 can be forwardly rotated. Specifically, the first stator 24 introduces the operating oil to the turbine 22 such that the directional vector of the flow of the operating oil can have a vector component in the forward-rotational direction.

When the operating oil is then introduced from the turbine 22 to the second stator 23 by the turbine blades 31, the second stator 23 is forwardly rotated by the operating oil. Then, the operating oil is introduced from the second stator 23 to the impeller 21 by the second stator blades 36. It should be noted that engine torque is amplified by the operating oil introduced to the impeller 21 by the second stator 23. Through the series of actions, the turbine 22 can be forwardly rotated in the torque converter 10.

### Clutch-on State

When the clutch 60 is being turned on, the first stator 24 and the second stator 23 are configured to be forwardly and reversely non-rotatable. When the impeller 21 is forwardly rotated under the condition, the operating oil is introduced from the impeller 21 to the first stator 24 by the impeller blades 27. Then, the operating oil is introduced from the first stator 24 to the turbine 22 by the first stator blades 125 locked by the clutch 60. Accordingly, the turbine 22 is reversely rotated by the operating oil. In other words, the first stator 24 introduces the operating oil to the turbine 22 such that the turbine 22 can be reversely rotated. Specifically, the first stator 24 introduces the operating oil to the turbine 22 such that the directional vector of the flow of the operating oil can have a vector component in the reverse-rotational direction.

Then, the operating oil is introduced from the turbine 22 to the second stator 23 by the turbine blades 31. Accordingly, the operating oil is introduced from the second stator 23 to the impeller 21 by the second stator blades 36 locked by the clutch 60. It should be noted that engine torque is amplified by the operating oil introduced to the impeller 21 by the second stator 23. Through the series of actions, the turbine 22 can be reversely rotated in the torque converter 10. Advantageous Effects of Power Transmission Device

In the present power transmission device 1, when the clutch 60 allows the first stator 24 and the second stator 23 to be rotated forwardly (i.e., rotated in the first rotational direction), the turbine 22 is forwardly rotated by the operating oil introduced by the first stator 24. On the other hand, when the clutch 60 restricts the first stator 24 and the second stator 23 from being rotated forwardly (i.e., rotated in the first rotational direction) and being rotated reversely (i.e., rotated in the second rotational direction), in other words, when the clutch 60 locks the rotation of the first stator 24 and that of the second stator 23, the turbine 22 is reversely rotated by the operating oil introduced by the first stator 24. In other words, depending on whether or not the rotation of the first stator 24 and that of the second stator 23 are allowed, the flow direction of the operating oil introduced by the first stator 24 is changed, and thereby, the rotational direction of the turbine 22 is changed. Thus, in the present power transmission device 1, power can be efficiently transmitted from the impeller 21 to the turbine 22 both when the turbine 22 is forwardly rotated and when the turbine 22 is reversely rotated. Further, unlike a well-known device, the present power transmission device 1 is not required to specially prepare a device for reverse rotation. Therefore, the present power transmission device 1 can be further reduced in its size in comparison with the well-known device.

When the impeller 21 is forwardly rotated in the present power transmission device 1, the first stator 24 is forwardly rotated by the operating oil introduced by the impeller 21. Further, the turbine 22 is forwardly rotated by the rotation of the first stator 24 as described above. Thus, even when the first stator 24 exists, power can be reliably transmitted from the impeller 21 to the turbine 22.

In the present power transmission device 1, the first stator 24 and the second stator 23 are configured to be unitarily rotatable. Therefore, the rotation of the first stator 24 and that of the second stator 23 can be simultaneously restricted by the clutch 60. In other words, the rotation of the first stator 24 and that of the second stator 23 can be simultaneously allowed or restricted. Accordingly, the flow direction of the operating oil introduced by the first stator 24 can be reliably changed. In other words, the rotational direction of the turbine 22 can be reliably changed.

When described in detail, in the present power transmission device 1, the first stator 24 is configured to be unitarily rotatable with the second stator 23. Therefore, when the rotation of the second stator 23 is restricted by the clutch 60, the rotation of the first stator 24 is also restricted. In other words, the rotation of the first stator 24 and that of the second stator 23 can be both restricted only by restricting the rotation of the second stator 23. Accordingly, it is not required to prepare a special device for restricting the rotation of the first stator 24. Therefore, the present power transmission device 1 can be reduced in its size.

In the present power transmission device 1, the first stator 24 is disposed on the outer peripheral side, whereas the second stator 23 is disposed on the inner peripheral side. Therefore, the present power transmission device 1 can be structured without remarkably changing the arrangement configuration of the impeller 21, the turbine 22 and the stator 23 in a well-kwon device. In other words, the present power transmission device 1 can be easily structured.

When in general, a continuously variable transmission is used, a power transmission device can forwardly rotate a pulley and so forth included in the continuously variable transmission without causing any problems. However, in attempting to reversely rotate the pulley and so forth, it is required to specially embed a gear or a mechanism corresponding to the gear into the transmission. In comparison with this, the present power transmission device 1 can reversely rotate the turbine 22 of the torque converter 10 only with the clutch 60 without preparing such special gear or mechanism. Therefore, the present power transmission device 1 can be reduced in its size.

### OTHER EXEMPLARY EMBODIMENTS

An exemplary embodiment of the present invention has been described above. However, the present invention is not limited to the aforementioned exemplary embodiment, and a variety of changes can be herein made without departing from the scope of the present invention. Especially, a plurality of exemplary embodiments and modifications described in the present specification can be arbitrarily combined on an as-needed basis.

(a) In the aforementioned exemplary embodiment, the case has been exemplified that the rotation of the first stator 24 is restricted when the clutch 60 restricts the rotation of the second stator 23. However, any of the stators can be restricted from being rotated as long as both of the first stator 24 and the second stator 23 can be restricted from being rotated. Even in this case, it is possible to achieve advantageous effects similar to those described above.

(b) In the aforementioned exemplary embodiment, the case has been exemplified that the first stator 24 and the second stator 23 are configured to be unitarily rotatable. However, the first stator 24 and the second stator 23 can be configured to be rotated independently from each other. In this case, it is possible to achieve advantageous effects similar to those described above by causing the clutch 60 to separately restrict the rotation of the first stator 24 and that of the second stator 23.

(c) In the aforementioned exemplary embodiment, the case has been exemplified that the continuously variable transmission is used. However, the present invention can be also applied to a case that a transmission of another type is used. Even in this case, it is possible to achieve advantageous effects similar to those described above.

### Advantageous Effects of Invention

According to the present invention, it is possible to provide a power transmission device that can efficiently transmit power.

### INDUSTRIAL APPLICABILITY

The present invention can be widely utilized for power transmission devices.

What is claimed is:

1. A power transmission device, comprising:
an impeller being disposed on an input side, the impeller configured to be rotated in a first rotational direction;
a turbine being disposed on an output side, the turbine configured to be rotated in either the first rotational direction or a second rotational direction opposite to the first rotational direction;
a first stator configured to be rotatable in the first rotational direction between the impeller and the turbine in order to transmit a power of the impeller to the turbine;
a second stator configured to be rotatable in the first rotational direction between the turbine and the impeller in order to transmit a power of the turbine to the impeller; and
a rotation restriction part configured to allow the first stator and the second stator to be rotated in the first rotational direction and restrict the first stator and the second stator from being rotated in the first rotational direction and the second rotational direction, wherein
the first stator is configured to introduce a fluid for transmitting the power to the turbine such that the turbine is rotated in the first rotational direction if the rotation restriction part allows the first stator and the second stator to be rotated in the first rotational direction, and
the first stator is configured to introduce the fluid to the turbine such that the turbine is rotated in the second rotational direction if the rotation restriction part restricts the first stator and the second stator from being rotated in the first rotational direction and the second rotational direction.

2. The power transmission device according to claim 1, wherein the impeller is configured to introduce the fluid to the first stator such that the first stator is rotated in the first rotational direction if the impeller is rotated in the first rotational direction.

3. The power transmission device according to claim 1 or 2, wherein the first stator and the second stator are configured to be unitarily rotatable.

4. The power transmission device according to claim 3, wherein the rotation restriction part is configured to restrict the first stator from being rotated by restricting the second stator from being rotated.

5. The power transmission device according to any one of claims 1 to 4, wherein
the first stator is disposed on an outer peripheral side and between the impeller and the turbine, and
the second stator is disposed on an inner peripheral side and between the turbine and the impeller.

6. The power transmission device according to any one of claims 1 to 5, wherein
the impeller, the turbine, the first stator and the second stator are included in a torque converter, and
the rotation restriction part is disposed in a transmission.
